(19) United States
(12) Patent Application Publication
(10) Pub. No.: US 2026/0004080 A1
(43) Pub. Date: Jan. 1, 2026

(54) SYNTHETIC DATA GENERATION FOR RETRIEVAL EVALUATION AND FINE-TUNING

(71) Applicant: NVIDIA Corporation, Santa Clara, CA (US)

(72) Inventors: Tanay VARSHNEY, San Jose, CA (US); Davide Marco ONOFRIO, San Francisco, CA (US)

(21) Appl. No.: 18/759,108

(22) Filed: Jun. 28, 2024

(51) Int. Cl. G06F 40/30

(52) U.S. Cl. CPC G06F 40/30

(57) ABSTRACT

In various examples, a technique for generating synthetic data includes inputting a first prompt that includes (i) a first portion of content and (ii) a plurality of user personas into a first machine learning model and generating, via the first machine learning model and based on the first prompt, a plurality of points of interest associated with the user personas and the first portion of content. The technique also includes inputting a second prompt that includes mappings between the points of interest and a plurality of question types into a second machine learning model and generating, via the second machine learning model and based on the second prompt, a plurality of questions associated with the user personas and the first portion of content. The technique further includes retrieving a second portion of content based at least on the plurality of questions and a third prompt.

### TECHNICAL FIELD

Embodiments of the present disclosure relate generally to natural language processing and machine learning and, more specifically, to techniques for generating synthetic data for finetuning and evaluating retrieval of content.

### BACKGROUND

Large language models (LLMs) include neural networks and/or other types of machine learning models that are capable of general-purpose language understanding and generation. LLMs are typically pre-trained on vast datasets of text and/or other types of content and include large numbers of parameters that allow the LLMs to learn complex patterns in the content. After pre-training of an LLM is complete, the LLM is capable of using the same types of content to perform a wide range of tasks. The performance of a given LLM on these tasks can then be evaluated and/or tracked to assess the strengths and weaknesses of the LLM, compare the capabilities of different LLMs, evaluate the effectiveness of datasets and/or techniques used to train and/or prompt the LLMs, and/or incorporate the LLM in applications and/or environments in which these tasks are performed.

However, LLMs are also capable of generating false and/or misleading information. In this respect, an LLM typically converts an input prompt in the form of text and/or other content into an abstraction of the content. The LLM then uses this abstraction and the patterns learned across the vast set of data used to train the LLM to generate a statistically likely response to the prompt. The LLM may additionally be trained using insufficient, biased, and/or inaccurate training data; overfitted to the training data; and/or lack understanding of the context and/or nuance associated with the prompt. These limitations in the training and reasoning capabilities of the LLM can cause the LLM to “hallucinate” output that appears plausible but is incorrect, nonsensical, and/or not in line with the context of the prompt.

To reduce hallucinations and improve the accuracy of LLM output, Retrieval-Augmented Generation (RAG) may be used to supplement a generative prompt with relevant external information. RAG involves converting a prompt into an embedding in a lower-dimensional latent vector space, using a vector similarity search to match the embedding to additional embeddings of unstructured content items in an available knowledge base, and retrieving a subset of content items with embeddings that are closest to the embedding of the prompt in the latent vector space. The retrieved content is then provided as additional input to the LLM to allow the LLM to generate a more accurate and/or relevant response to the prompt.

However, the effectiveness of RAG in improving LLM output is tied to the retrieval of content that is relevant to a given prompt. When the embeddings used in the retrieval process do not reflect the nuances of the prompt and/or the content in the knowledge base, the retrieved content may be irrelevant to the prompt and therefore fail to improve the accuracy and/or quality of the corresponding response by the LLM.

Existing approaches for improving the retrieval of unstructured content involve prompting LLMs to generate a variety of questions from a “chunk” of content (e.g., a passage of text from a document). The generated questions may then be paired with the chunk of content for the purposes of evaluating and/or fine-tuning embedding models in RAG workflows. However, the generated questions tend to be robotic, formulaic, and narrow in scope and therefore fail to capture the diversity, nuance, perspectives, and styles associated with real-world questions from users. Consequently, the generated questions may be unable to fully test the performance of the embedding models and/or improve the use of embeddings generated by the embedding models in matching user prompts to relevant content.

As the foregoing illustrates, what is needed in the art are more effective techniques for retrieving content that is relevant to LLM prompts and/or other user input.

### BRIEF DESCRIPTION OF DRAWINGS

FIG. 1 illustrates a block diagram of a computing system configured to implement one or more aspects of at least one embodiment;

FIG. 2 is a more detailed illustration of the data-generation pipeline, management engine, and execution engine of FIG. 1, according to at least one embodiment;

FIG. 3 illustrates a flow diagram of a method for generating synthetic questions from content, according to at least one embodiment;

FIG. 4A illustrates inference and/or training logic, according to at least one embodiment;

FIG. 4B illustrates inference and/or training logic, according to at least one embodiment;

FIG. 5 illustrates training and deployment of a neural network, according to at least one embodiment;

FIG. 6A is a block diagram of an example generative language model system suitable for use in implementing some embodiments of the present disclosure;

FIG. 6B is a block diagram of an example generative language model that includes a transformer encoder-decoder suitable for use in implementing some embodiments of the present disclosure;

FIG. 6C is a block diagram of an example generative language model that includes a decoder-only transformer architecture suitable for use in implementing some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

As discussed herein, limitations in the training and reasoning capabilities of LLMs, VLMs, multi-modal language models, and/or other model types can cause the models to “hallucinate” output that appears plausible but is incorrect, nonsensical, and/or not in line with the context of the prompt. However, Retrieval-Augmented Generation (RAG) approaches that supplement a prompt inputted into an LLM, VLM, etc. with external content may fail to improve the quality of the resulting output when the content is irrelevant to the prompt. Further, existing approaches for evaluating and/or improving the retrieval of unstructured content by a RAG workflow may result in the generation of questions that lack the diversity, nuance, perspectives, and styles associated with real-world users.

To address the above limitations, the disclosed techniques generate synthetic data that can be used to evaluate and/or improve the retrieval of content based on a prompt and/or other input. This synthetic data may include a diverse and customizable set of synthetic questions that are relevant to different portions of content and reflect a variety of user demographics, interests, communication styles, and/or backgrounds.

A multi-stage pipeline is used to generate the synthetic questions using a set of content and a set of user personas. Each stage in the multi-stage pipeline may be implemented using prompts to LLMs, VLMs, multi-modal language models, other model types, and/or embedding models. The pipeline includes a first stage that identifies points of interest within different portions of the content based on descriptions of various user personas, including (but not limited to) communication styles, interests, backgrounds, levels of knowledge, habits, and/or other characteristics of each user persona. Each point of interest represents a topic, theme, sentiment, and/or another entity that is associated with a corresponding portion of content (e.g., a passage from a document) and determined to be of interest to one or more user personas. The first stage also maps these points of interest to different types of questions (e.g., extractive, abstractive, aggregative, etc.) that can be asked and uses the mappings between the points of interest and types of questions are to generate a comprehensive set of potential questions that can be asked of the portion of content.

The pipeline also includes a second stage that applies various filters to the generated questions. These filters may be used to remove semantically duplicated questions, questions that cannot be answered using corresponding portions of content, robotic-sounding questions, general knowledge questions, and/or other types of questions with attributes that are determined to be “undesirable” for the purposes of evaluating and/or improving the retrieval of content. These filters may also, or instead, be used to rephrase questions to be more conversational and/or less formal.

The pipeline additionally includes a third stage that generates variants of the filtered questions. This stage involves prompting an LLM, VLM, etc. to convert a given question into a variant that reflects the style and/or tone of a given persona. Questions generated by the pipeline may then be paired with the corresponding portions of content and used to evaluate and/or fine-tune embedding models, RAG implementations, and/or LLMs/VLMs/etc. in answering questions using retrieved content.

One technical advantage of the disclosed techniques relative to prior approaches is the ability to generate, filter, and/or rewrite a diverse set of synthetic questions in a way that is tailored to different types of content and/or the nuances, interests, communication styles, and/or backgrounds of a set of customizable user personas. Consequently, the disclosed techniques allow embedding models, LLMs, VLMs, multi-modal language models, other model types, and/or other components of RAG workflows to be evaluated and/or fine-tuned more thoroughly than conventional approaches that generate questions that are robotic, formulaic, and/or narrow in scope. Additionally, the customization of the generated questions to different types of content, personas, types of questions, and/or attributes of questions allow the evaluation and/or fine-tuning of RAG components to be targeted toward different use cases, purposes, and/or priorities. Further, because the generated questions are filtered, deduplicated, and/or rewritten without adversely impacting the diversity of the generated questions, the disclosed techniques can be used to generate a synthetic dataset that is diverse, balanced, and representative of user-generated input into LLMs/VLMs/multi-modal language models/etc. The disclosed techniques may thus improve resource overhead and/or retrieval performance compared with conventional approaches that use less diverse, unique, and/or balanced questions to evaluate and/or fine-tune RAG components.

The above examples are not in any way intended to be limiting. As persons skilled in the art will appreciate, as a general matter, the techniques for automatically generating dialogue flows from unlabeled conversation data can be implemented in any suitable application.

The systems and methods described herein may be used for a variety of purposes, by way of example and without limitation, for use in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as LLMs/VLMs/multi-modal language models/other model types that may process text, audio, 3D data, and/or image data, systems for performing light transport simulation, systems for performing collaborative content creation for 3D assets, systems implemented at least partially using cloud computing resources, systems for performing generative AI operations, and/or other types of systems.

### System Overview

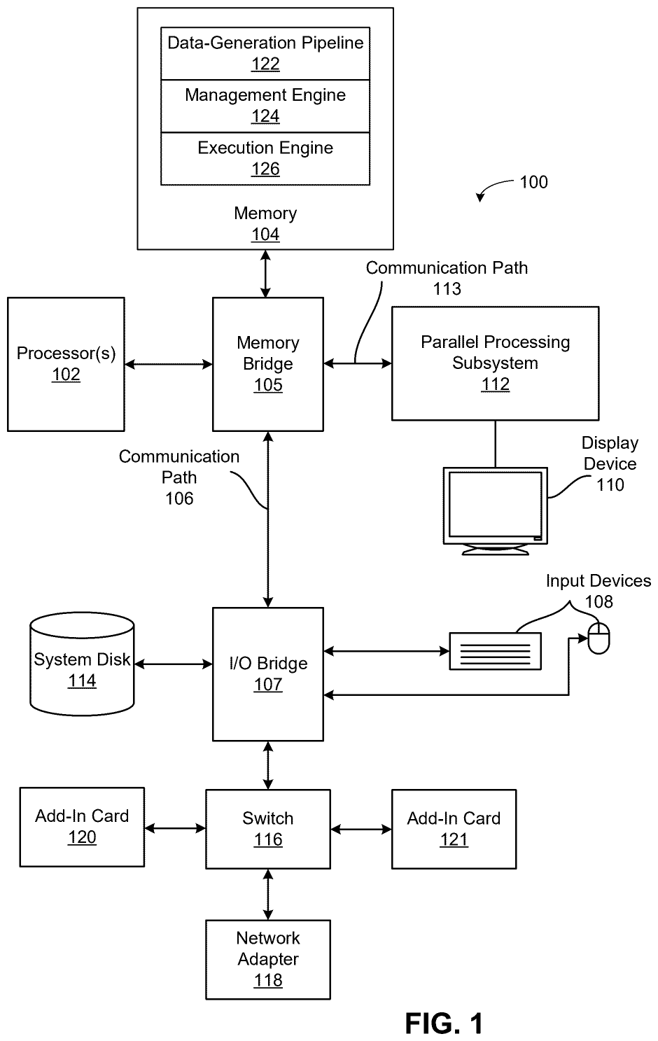

FIG. 1 is a block diagram illustrating a computing system 100 configured to implement one or more aspects of at least one embodiment. In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine operating in a data center or a cloud computing environment that provides scalable computing resources as a service over a network.

In various embodiments, computing system 100 includes, without limitation, one or more processors 102 and one or more memories 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as (but not limited to) a keyboard, mouse, touch screen, sensor data analysis (e.g., evaluating gestures, speech, or other information about one or more uses in a field of view or sensory field of one or more sensors), a VR/MR/AR headset, a gesture recognition system, a steering wheel, mechanical, digital, or touch sensitive buttons or input components, and/or a microphone, and forward the input information to processor(s) 102 for processing. In at least one embodiment, computing system 100 may be a server machine in a cloud computing environment. In such embodiments, computing system 100 may omit input devices 108 and receive equivalent input information as commands (e.g., responsive to one or more inputs from a remote computing device) and/or messages transmitted over a network and received via the network adapter 118. In at least one embodiment, switch 116 is configured to provide connections between I/O bridge 107 and other components of computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point-to-point communication protocol known in the art.

In at least one embodiment, parallel processing subsystem 112 includes a graphics subsystem that delivers pixels to an optional display device 110 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In at least one embodiment, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memor(ies) 104 include at least one device driver configured to manage the processing operations of the one or more PPUs within parallel processing subsystem 112. In addition, memor(ies) 104 include a data-generation pipeline 122, a management engine 124, and an execution engine 126, which can be executed by processor(s) and/or parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on a chip (SoC).

Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing system 100 may correspond to a physical computing system (e.g., a system in a data center or a machine) and/or may correspond to a virtual computing instance executing within a computing cloud.

In at least one embodiment, processor(s) 102 issue commands that control the operation of PPUs. In at least one embodiment, communication path 113 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in at least one embodiment, memor(ies) 104 may be connected to processor(s) 102 directly rather than through memory bridge 105, and other devices may communicate with memor(ies) 104 via memory bridge 105 and processors 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 may be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

In some embodiments, data-generation pipeline 122, management engine 124, and execution engine 126 include functionality to generate and use synthetic data to evaluate and/or improve the retrieval of content based on a prompt and/or other input. Management engine 124 coordinates the operation of data-generation pipeline 122 in generating the synthetic data. This synthetic data may include a diverse and customizable set of synthetic questions that are relevant to different portions of structured and/or unstructured content and reflect a variety of user demographics, interests, communication styles, and/or backgrounds.

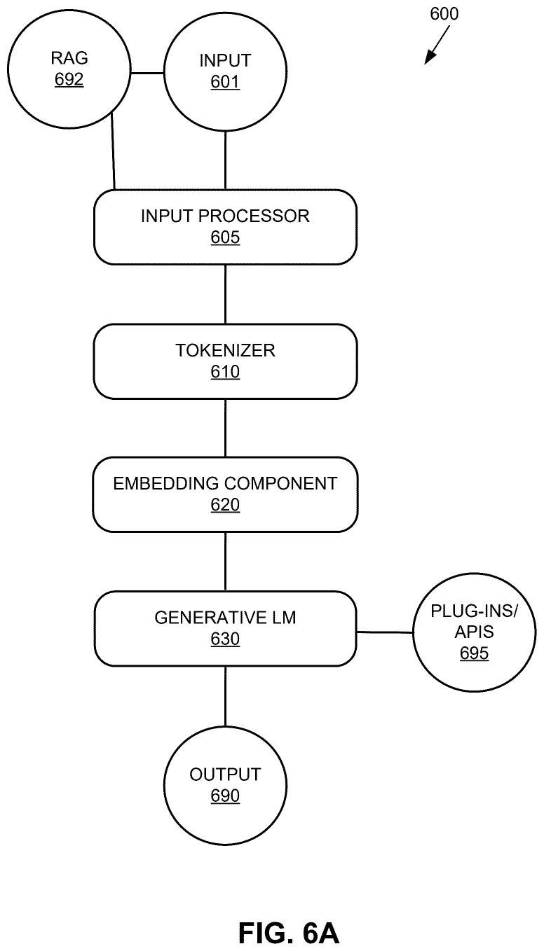

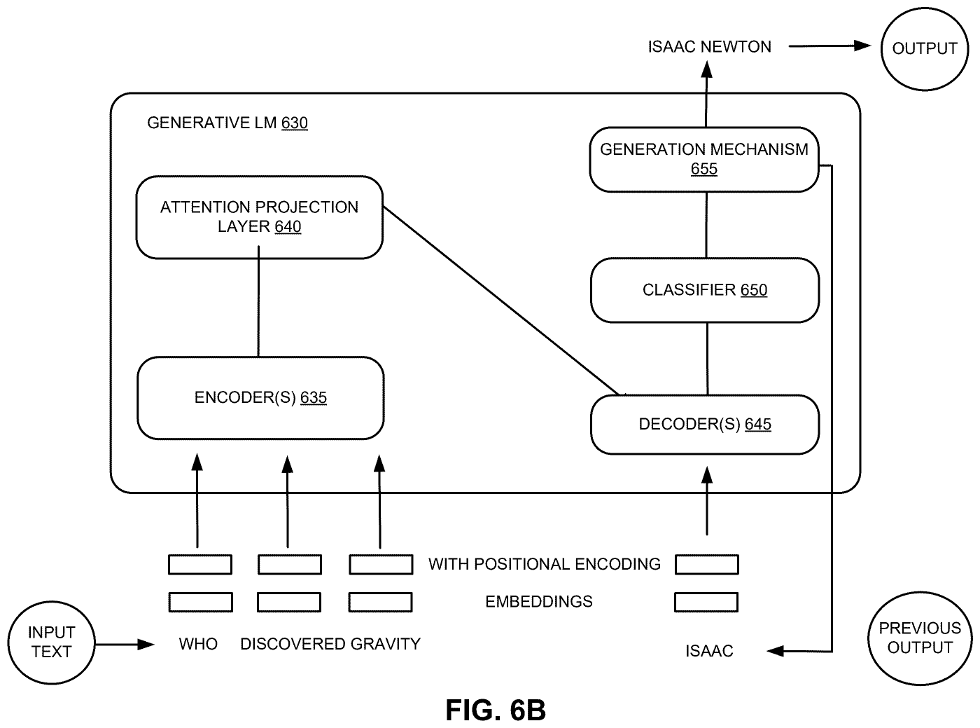

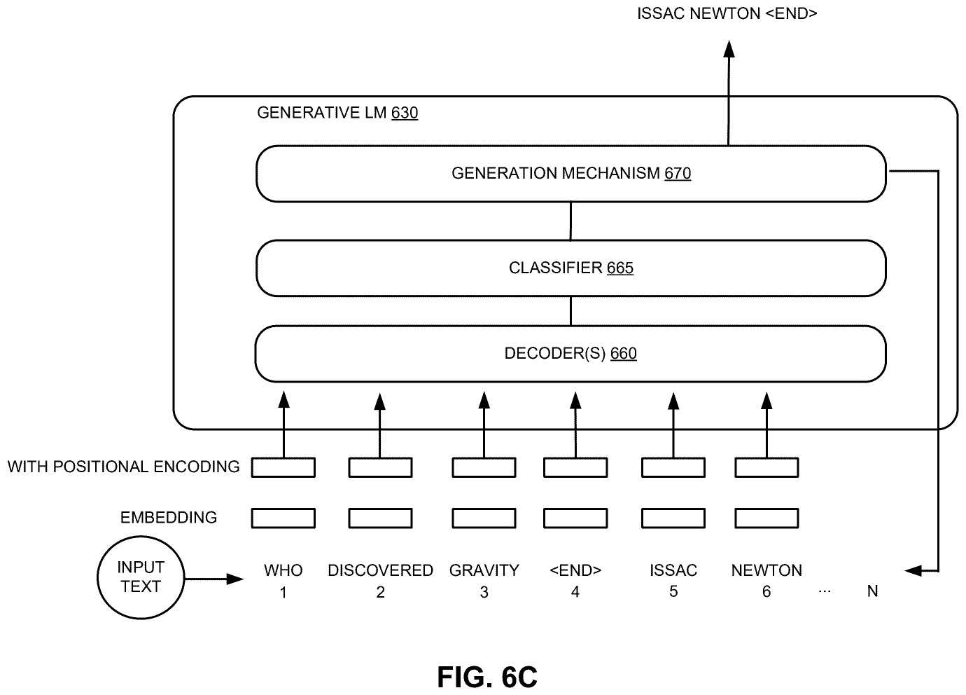

Data-generation pipeline 122 includes multiple stages that are implemented using prompts to LLMs, VLMs, multi-modal language models, other (e.g., language) model types (as discussed herein with respect to FIGS. 6A-6C), and/or embedding models. A first stage in data-generation pipeline 122 identifies points of interest within the content based on descriptions of various user personas, including (but not limited to) communication styles, interests, backgrounds, levels of knowledge, habits, and/or other characteristics of each user persona. Each point of interest represents a topic, theme, and/or another entity that is associated with a given portion of content (e.g., a passage from a document) and determined to be of interest to one or more user personas. These points of interest are mapped to different types of questions (e.g., extractive, abstractive, aggregative, etc.) that can be asked. Mappings between the points of interest and types of questions are then used to generate a comprehensive set of potential questions that can be asked of the portion of content.

A second stage in data-generation pipeline 122 applies various filters to the generated questions. These filters may be used to remove semantically duplicated questions, questions that cannot be answered using corresponding portions of content, robotic-sounding questions, general knowledge questions, and/or other types of questions with attributes that are determined to be “undesirable” for the purposes of evaluating and/or improving the retrieval of unstructured content. These filters may also, or instead, be used to rephrase questions to be more conversational and/or less formal.

A third stage in data-generation pipeline 122 generates variants of the filtered questions. This stage involves prompting an LLM/VLM/etc. to convert a given question into a variant that reflects the style and/or tone of a given persona.

Execution engine 126 uses the output of data-generation pipeline 122 to improve the retrieval of content. For example, execution engine 126 may use questions generated by the pipeline that are paired with the corresponding chunks of content to execute, evaluate, and/or fine-tune embedding models, vector databases, LLMs, VLMs, multi-modal language models, and/or other RAG components. Data-generation pipeline 122, management engine 124, and execution engine 126 are described in further detail below.

### Synthetic Data Generation for Unstructured Retrieval Evaluation and Fine-Tuning

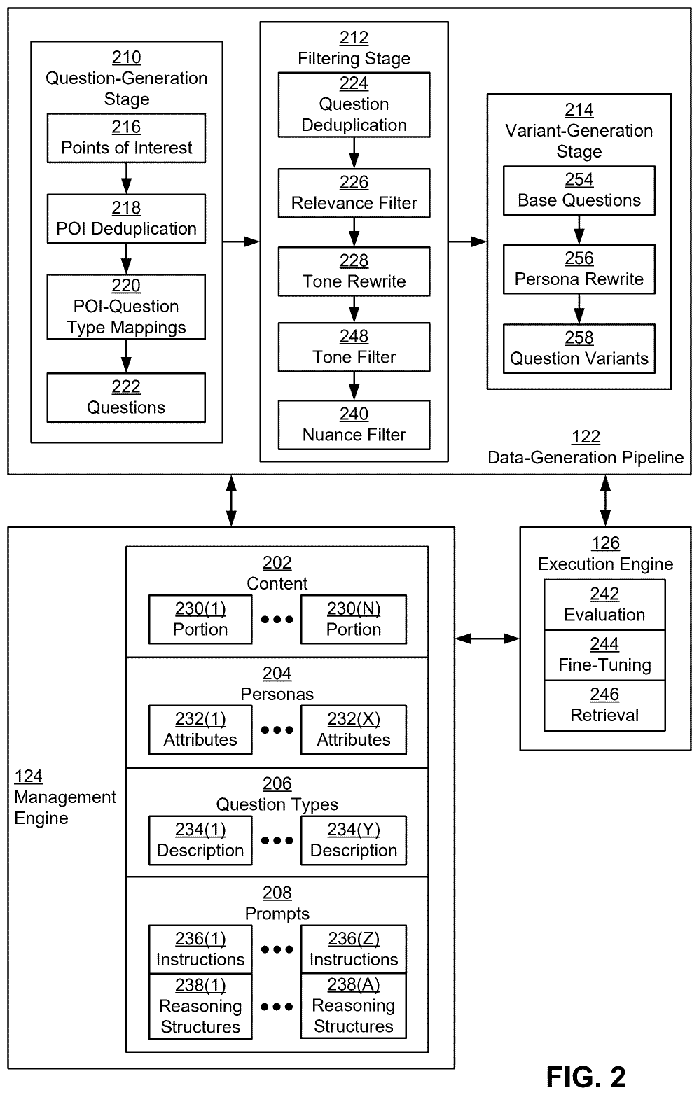

FIG. 2 is a more detailed illustration of data-generation pipeline 122, management engine 124, and execution engine 126 of FIG. 1, according to at least one embodiment. As discussed herein, data-generation pipeline 122, management engine 124, and execution engine 126 include functionality to generate and use synthetic data to evaluate and/or improve the retrieval of unstructured content based on a prompt and/or other input.

Data-generation pipeline 122 includes multiple stages that are executed to generate a set of synthetic questions that can be customized to different portions 230(1)-230(N) (each of which is referred to individually herein as portion 230) of structured and/or unstructured content 202, attributes 232(1)-232(X) (each of which is referred to individually herein as attributes 232) associated with various personas 204, and/or descriptions 234(1)-234(Y) (each of which is referred to individually herein as description 234) of different question types 206. As shown in FIG. 2, management engine 124 generates, collects, organizes, and/or provides portions 230 of content 202, attributes 232 of personas 204, descriptions 234 of question types 206, and/or other data that is used by data-generation pipeline 122 to generate the synthetic questions.

Content 202 includes various types of structured and/or unstructured data. For example, each portion 230 may include a passage of text and/or excerpt from one or more documents (e.g., articles, reports, essays, books, short stories, poems, etc.), visual data (e.g., images, videos, graphs, charts, tables, etc.), audio data (e.g., voice recordings, sound recordings, music, etc.), sensor data, three-dimensional (3D) data (e.g., point clouds, meshes, 3D models, universal scene descriptor (USD) data objects, etc.), and/or another type of content 202.

In some embodiments, management engine 124 divides content 202 into discrete portions 230. For example, management engine 124 may use named entity recognition, natural language processing, machine learning, and/or other techniques to parse and divide text-based content 202 into smaller portions 230 based on criteria such as (but not limited to) thematic boundaries (e.g., subject matter, themes, etc.), logical separations (e.g., sentence boundaries, paragraph boundaries, etc.), content markers (e.g., headings, sub-headings, etc.), and/or length of text (e.g., word counts, character counts, etc.). Portions 230 may include disjoint subsets of content 202 and/or overlap with one another within content 202. After portions 230 are generated, management engine 124 may annotate and/or tag each portion 230 with keywords, entities, topics, sentiments, and/or other metadata that semantically describes the content.

Personas 204 include representations of different types of users that may ask questions and/or provide input related to portions 230 of content 202. Each persona is associated with a set of attributes 232 for the corresponding type of user. Examples of attributes 232 associated with a given persona include (but are not limited to) a name, role, behavioral trait, emotion, demographic attribute, communication style, level of knowledge, level of education, attitude, motivation, interest, and/or goal. Personas 204 may be user-defined, generated using machine-learning techniques, and/or otherwise specified.

An example set of personas 204 includes the following representation:

PERSONAS = [
“““

Joan is a CFO. Joan is used to having a team of analysts who they can ask for information, so they haven't read any of the materials themselves and aren't familiar with the exact contents or where to find information. However, they are very knowledgeable about the general topic and ask very specific, targeted, and analytical questions.

“““,
”””

Aaron is a customer support agent within a technical support department. They have general knowledge about the company's products and technical aspects, but are not experts in the contents of the knowledge base and often don't use the right keywords. The knowledge base is extensive and constantly evolving, making it challenging for agents to keep up with all the details. Aaron needs efficient access to accurate, up-to-date information which is relevant to the customer's question as well as efficient summarization of granular details. Aaron's inputs are often questions in the form of statements, and are very concise.

“““,
”””

Miguel is a legal advisor ensuring the company complies with laws and regulations. He needs to find precise regulatory guidelines, compliance documents, and legal precedents to ensure products and operations are legally sound. Miguel is highly knowledgeable about legal documents but may need assistance with specific updates or cases, and can have a lot of ambiguity in their questions despite needing detailed information.

“““,
”””

Samantha is a sales rep selling enterprise software to businesses. To effectively pitch to clients, they need quick access to clear, concise product info, benefits, competitive analysis, and customer testimonials. Samantha knows the main selling points but struggles with inconsistent, incomplete technical details to tailor their pitches.

“““,
”””

Leila is a scientist conducting biotechnology research. To support their projects, they need to access the latest research findings, experimental data, and scientific literature. Leila is deeply familiar with scientific research and tends to ask questions with a lot of contextual information and conditional requirements, as they know exactly what they are looking for.

“““,
”””

Emma is an HR manager handling recruitment, employee relations and policies. They need accurate, up-to-date company policies, best practices, and legal requirements to support HR decisions. Emma is moderately familiar with general policies so while they are looking for specific facts and procedural information, Emma tends to use incorrect terminology and layperson language when asking questions.

“““,
”””

Jack is a financial analyst evaluating investments and performance. To support decisions, they require detailed, accurate financial reports, market analyses and economic forecasts. Jack is familiar with financial data but consolidating comprehensive, current information from various sources led to delays. Jack tends to have a lot of typos and errors in their typing, and rarely uses the appropriate punctuation.

“““,
”””

Malik is a marketing specialist planning and executing e-commerce campaigns. They need detailed analytics, customer insights and market trends to optimize strategies. Malik knows marketing principles but struggles integrating data from multiple sources to derive actionable insights. Sofia asks very concise but open-ended questions.

“““,
”””

Aldemar is a technical writer creating user manuals and documentation. To produce clear guides, they require precise, up-to-date technical info and explanations. Aldemar is highly familiar with technical concepts but spent excessive time manually gathering and verifying specific details. Aldemar is not a native English speaker but uses English at work.

“““,
”””

Fatima is a government financial analyst monitoring spending, assessing fiscal health, conducting audits, and developing policies. They need on-demand access to accurate, up-to-date information to frequently manage public funds, ensure compliance, evaluate performance, and guide municipal strategies. Fatima is deeply knowledgeable about municipal finance and public administration, and tends to ask very verbose and grammatically complex questions.

“““,
”””

Amy is an energetic college student, but is in the habit of asking incomplete questions that are vague. She is a performing arts major.

“““
]

In the above example, attributes 232 associated with a given persona may include a name (e.g., “Joan,” “Aaron,” “Miguel,” etc.), a role (e.g., “CFO, “customer support agent,” “legal advisor,” etc.), and/or a set of responsibilities or needs (e.g., “efficient access to accurate, up-to-date information which is relevant to the customer's question as well as efficient summarization of granular details”). Attributes 232 may also include a description of the type of knowledge, level of knowledge, and/or level of detail associated with knowledge possessed by the corresponding personas 204 (e.g., “highly knowledgeable about legal documents but may need assistance with specific updates or cases”). Attributes 232 may further include a description of the writing and/or communication styles of the corresponding personas 204 (e.g., “tends to ask very verbose and grammatically complex questions”).

Question types 206 specify the different types of questions that can be asked. Each question type is defined using a corresponding description 234. As with personas 204, question types 206 may be user-defined, generated using machine-learning techniques, and/or otherwise specified.

An example set of question types 206 includes the following representation:

```
  TYPES_OF_QUESTION = [
  “Extractive, i.e., the question can be answered from objective information present in the
context.”,
  “Abstractive, i.e., to answer the question, some reasoning is required to be done on the context
rather than the answer being directly extracted from the context.”,
  “Verification based, i.e., true or false questions.”,
  “Aggregative, i.e., some form of collectivization like making a group, or counting the number
of items needs to be done using the information in context to answer the question.”,
  “Sentiment driven, i.e., the question is about a sentiment that can be extracted from the
context.”,
  “Diagnostic, i.e., the question is about constructing a diagnosis that can be inferred from the
context.”,
  “Interpretive, i.e., the question is a qualitative question that can only answered by interpreting
the context from a particular point of view.”,
  “Definitive, i.e., the question is about a definition that can be extracted from the given
context.”
]
```

In the above example, each question type is associated with a name (e.g., “Extractive,” “Abstractive,” etc.). The name is followed by an accompanying description 234 of the question type (e.g., “the question can be answered from objective information present in the context”).

Management engine 124 additionally generates and/or provides a set of prompts 208 that are used by data-generation pipeline 122 to generate synthetic questions related to portions 230, attributes 232, and/or question types 206. Prompts 208 include instructions 236(1)-236(Z) (each of which is referred to individually herein as instructions 236) that are provided to large language models (LLMs), vision language models (VLMs), multi-modal language models, and/or other types of machine learning models. Each set of instructions 236 may define a task to be performed by a machine learning model, input into the task, output of the task, and/or other parameters associated with the task. For example, instructions 236 may specify that a machine learning model is to generate data related to portions 230, attributes 232, and/or question types 206 and/or evaluate the data generated by a different machine learning model based on various criteria.

Prompts 208 may also include reasoning structures 238(1)-238(A) (each of which is referred to individually as reasoning structures 238) that describe the types of reasoning to be applied by the machine learning model during the corresponding tasks. For example, reasoning structures 238 may be generated by an LLM/VLM/etc. for various tasks associated with data-generation pipeline 122 under a Self-Discover framework. Using the Self-Discover framework, an LLM, VLM, and/or another type of language model may be prompted to analyze a current task, select and/or adapt appropriate reasoning modules for that task, and/or generate a task-specific reasoning structure 238 to guide the output of the language model on that task. Prompts 208, instructions 236, and reasoning structures 238 are described in further detail below with respect to the operation of data-generation pipeline 122.

As shown in FIG. 2, data-generation pipeline 122 includes a question-generation stage 210, a filtering stage 212, and a variant-generation stage 214. Each stage includes a sequence of operations that is performed by data-generation pipeline 122 using portions 230 of content 202, personas 204, question types 206, and/or prompts 208 from management engine 124 and LLMs, VLMs, multi-modal language models, embedding models, and/or other machine learning models. The output of a given stage of data-generation pipeline 122 is used as input into a subsequent stage of data-generation pipeline 122.

More specifically, data-generation pipeline 122 begins with question-generation stage 210, in which data-generation pipeline 122 generates a set of questions 222 that are relevant to a given portion 230 of content 202. During question-generation stage 210, data-generation pipeline identifies a set of points of interest 216 associated with one or more portions 230 of content 202 and/or one or more personas 204.

In some embodiments, points of interest 216 include topics, themes, sentiments, and/or other entities that are associated with a corresponding portion 230 of content 202 and determined to be of interest to a corresponding persona. To generate points of interest 216, data-generation pipeline 122 inputs (i) a certain portion 230 of content 202, (ii) attributes 232 of a persona, and (iii) a prompt that includes one or more instructions 236 and/or one or more reasoning structures 238 into an LLM and/or another machine learning model. In response to the input, the machine learning model generates a list of points of interest 216 that are relevant to both that portion 230 of content 202 and the persona.

For example, input into a machine learning model that is used to generate points of interest 216 may include the following representation:
You are given a Persona, and a Passage. Your task is to extract a list of angles of interest that may be of interest to the Persona from the Passage.

<Persona>
{persona}
</Persona>
<Passage>
The following information is from a file with the title “{file_name}”.
{passage}
</Passage>
Answer format - Generate a JSON with the following fields
- “list_of_interests”: [<fill with 1-5 word descriptions>]

Use Reflective Thinking: Step back from the problem, take the time for introspection and self-reflection. Examine personal biases, assumptions, and mental models that may influence problem-solving, and being open to learning from past experiences to improve future approaches. Show your thinking before giving an answer.

The example input includes instructions 236 of “You are given a Persona, and a Passage. Your task is to extract a list of angles of interest that may be of interest to the Persona from the Passage.” The example input also includes a placeholder of “{persona}” for attributes 232 of a persona and a different placeholder of “{passage}” for a certain portion 230 of content 202 for which points of interest 216 are to be generated. The example input specifies that the output of the machine learning model should be in JavaScript Object Notation (JSON) format and include a field named “list_of_interests” that is populated with 1-5 word descriptions of points of interest 216 for that portion 230 of content 202. The example input further includes a reasoning structure of “Use Reflective Thinking: Step back from the problem, take the time for introspection and self-reflection. Examine personal biases, assumptions, and mental models that may influence problem-solving, and being open to learning from past experiences to improve future approaches. Show your thinking before giving an answer.”

After points of interest 216 are generated for a given portion 230 of content 202 and a set of personas 204 (e.g., some or all personas 204 available to management engine 124), data-generation pipeline 122 performs POI deduplication 218, in which data-generation pipeline 122 deduplicates points of interest 216 based on the semantic content of each point of interest. For example, data-generation pipeline 122 may use an embedding model to convert each point of interest into an embedding in a lower-dimensional vector space. Data-generation pipeline 122 may perform agglomerative clustering of the embeddings until the distances between embeddings in each cluster reach or exceed a threshold. Data-generation pipeline 122 may then select a single “representative” embedding from each cluster (e.g., an embedding that is closest to the centroid of each cluster and/or matches other selection criteria) and add the corresponding point of interest to a smaller deduplicated set of points of interest 216.

After POI deduplication 218 is complete, data-generation pipeline 122 generates POI-question type mappings 220 between the deduplicated points of interest 216 and question types 206. Each mapping indicates that a given point of interest is associated with a corresponding question type.

To generate POI-question type mappings 220, data-generation pipeline 122 inputs (i) a certain portion 230 of content 202, (ii) a point of interest from the deduplicated points of interest 216, (iii) a set of question types 206, and (iv) a prompt that includes one or more instructions 236 and/or one or more reasoning structures 238 into an LLM, VLM, multi-modal language model, and/or another machine learning model. In response to the input, the machine learning model generates a list of points of interest 216 that are relevant to both that portion 230 of content 202 and the persona.

For example, input into a machine learning model that is used to generate POI-question type mappings 220 may include the following representation:
You are a teacher/professor and are given a point of interest, types of questions, and a Passage. Your task is to narrow down the types of questions that can be reasonably extracted from the Passage for an upcoming test.

<Point of Interest>
{interest}
</Point of Interest>
<Types of Questions>
{types}
</Types of Questions>
<Passage>
The following information is from a file with the title “{file_name}”.
{passage}
</Passage>
Answer format - Generate a JSON with the following fields
- “list_of _types_of_questions”: [<fill>]

Use Reflective Thinking: Step back from the problem, take the time for introspection and self-reflection. Examine personal biases, assumptions, and mental models that may influence problem-solving, and being open to learning from past experiences to improve future approaches. Show your thinking before giving an answer. DON'T SOLVE.

The example input includes instructions 236 of “You are a teacher/professor and are given a point of interest, types of questions, and a Passage. Your task is to narrow down the types of questions that can be reasonably extracted from the Passage for an upcoming test.” The example input also includes placeholders of “{interest},” “{types},” and “{passage}” for a point of interest, a set of question types 206, and a certain portion 230 of content 202, respectively. The example input specifies that the output of the machine learning model should be in JSON format and include a field named “list_of_types_of_questions” that is populated with question types 206 that are relevant to the point of interest. The example input further includes a reasoning structure of “Use Reflective Thinking: Step back from the problem, take the time for introspection and self-reflection. Examine personal biases, assumptions, and mental models that may influence problem-solving, and being open to learning from past experiences to improve future approaches. Show your thinking before giving an answer. DON'T SOLVE.”

Data-generation pipeline 122 then uses POI-question type mappings 220 to generate a set of questions 222 for a given portion 230 of content 202. To generate questions 222, data-generation pipeline 122 inputs (i) that portion 230 of content 202, (ii) a point of interest from the deduplicated points of interest 216, (iii) a set of question types 206 mapped to the point of interest, and (iv) a prompt that includes one or more instructions 236 and/or one or more reasoning structures 238 into an LLM and/or another machine learning model. In response to the input, the machine learning model outputs questions 222 that are relevant to that portion 230 of content 202 and the persona.

For example, input into a machine learning model that is used to generate questions 222 may include the following representation:
You are a teacher/professor. Your task is to set up questions for an examination. Generate as many questions about {interest} as possible from the given Passage. The questions need to be {types}.

<Passage>
The following information is from a file with the title “{file_name}”.
{passage}
</Passage>
Answer format - Generate a JSON with the following fields
- “list_of_generated_questions”: [<fill>]

Use Reflective Thinking: Step back from the problem, take the time for introspection and self-reflection. Examine personal biases, assumptions, and mental models that may influence problem-solving, and being open to learning from past experiences to improve future approaches. Show your thinking before giving an answer.

The example input includes instructions 236 of “You are a teacher/professor. Your task is to set up questions for an examination. Generate as many questions about {interest} as possible from the given Passage. The questions need to be {types}.” Instructions 236 include placeholders of “{interest}” and “{types}” for a point of interest and a set of question types 206 mapped to the point of interest, respectively. The input includes an additional placeholder of “{passage}” for a given portion 230 of content 202 for which questions 222 are to be generated. The input specifies that the output of the machine learning model should be in JSON format and include a field named “list_of_generated_questions” that is populated with the generated questions 222. The example input further includes a reasoning structure of “Use Reflective Thinking: Step back from the problem, take the time for introspection and self-reflection. Examine personal biases, assumptions, and mental models that may influence problem-solving, and being open to learning from past experiences to improve future approaches. Show your thinking before giving an answer.”

After questions 222 have been generated for all POI-question type mappings 220 associated with a given portion 230 of content 202, data-generation pipeline 122 proceeds to filtering stage 212. During filtering stage 212, data-generation pipeline 122 applies various filters and/or transformations to questions 222 outputted by question-generation stage 210. First, data-generation pipeline 122 performs question deduplication 224, in which data-generation pipeline 122 deduplicates questions 222 based on the semantic content of each question. For example, data-generation pipeline 122 may use an embedding model to convert each question into an embedding in a lower-dimensional vector space. Data-generation pipeline 122 may also perform agglomerative clustering of the embeddings until distances between embeddings within a given cluster meet or exceed a threshold. Data-generation pipeline 122 may then select a single “representative” embedding from each cluster (e.g., an embedding that is closest to the centroid of each cluster and/or matches other selection criteria) and add the corresponding question to a smaller deduplicated set of questions 222.

After question deduplication 224 is complete, data-generation pipeline 122 applies a relevance filter 226 to the deduplicated questions 222. In some embodiments, relevance filter 226 is used to identify and/or filter deduplicated questions 222 that are not relevant to the corresponding portions 230 of content 202. To implement relevance filter 226, data-generation pipeline 122 inputs (i) a given portion 230 of content 202, (ii) a question generated for that portion 230 of content 202, and (iii) a prompt that includes one or more instructions 236 and/or one or more reasoning structures 238 into an LLM and/or another machine learning model. In response to the input, the machine learning model generates output indicating whether or not the question is relevant to that portion 230 of content 202 and/or the degree to which the question is relevant to that portion 230 of content 202.

For example, input into a machine learning model that is used to implement relevance filter 226 may include the following representation:
You are a juror tasked with giving a judgement as to whether there is enough evidence in the passage to answer a given question. Do not make assumptions or use your existing knowledge. The evidence should be in the passage. The existence of pointers to the evidence in the passage does not qualify as sufficiently useful.

Question: {question}
<Passage>
The following information is from a file with the title “{file_name}”.
{passage}
</Passage>
<Judgements-Options>
- “Beyond a reasonable doubt” - There is enough evidence in the passage to completely
answer the question beyond a reasonable doubt. We do not require further action on the
information in the passage to get to the evidence.
- “Somewhat relevant” - Only part of the evidence required to completely answer the
question is available in the passage. More information is required to answer the question,
or this evidence points to other evidence.
- “Not useful” - The passage doesn't contain enough information to answer the question.
</Judgement-Options>
Answer format - Generate your answer in JSON format with the following fields
“Reason”: <fill with 1-10 words of reasoning>
“Your_Decision”: <fill with “Beyond a reasonable doubt”, “Somewhat relevant” or “Not
useful”>

The example input includes instructions 236 of “You are a juror tasked with giving a judgement as to whether there is enough evidence in the passage to answer a given question. Do not make assumptions or use your existing knowledge. The evidence should be in the passage. The existence of pointers to the evidence in the passage does not qualify as sufficiently useful.” The input includes placeholders of “{question}” and “{passage}” to denote a question and portion 230 of content 202, respectively. The example input further includes three possible choices of “Beyond a reasonable doubt,” “Somewhat relevant,” and “Not useful” and specifies that the output of the machine learning model should be in JSON format and include (i) a “Reason” field that is to be populated with a 1-10 word reason for a given choice and (ii) a “Your_Decision” field that is to be populated with the choice. Output generated by the machine learning model from the input may then be used to drop questions 222 that are deemed “Not useful” and/or “Somewhat relevant.”

Next, data-generation pipeline 122 performs a tone rewrite 228 of questions 222 that have passed relevance filter 226. In one or more embodiments, tone rewrite 228 involves rewriting questions 222 in a more conversational tone. To perform tone rewrite 228, data-generation pipeline 122 inputs (i) a given portion 230 of content 202, (ii) a question generated for that portion 230 of content 202, and (iii) a prompt that includes one or more instructions 236 and/or one or more reasoning structures 238 into an LLM and/or another machine learning model. In response to the input, the machine learning model generates output that includes a rephrasing of the question according to criteria specified in the prompt.

For example, input into a machine learning model that is used to perform tone rewrite 228 may include the following representation:
Your task is to make minor edits to Old_Question if needed to make it sound “Natural”. Replace generic pronouns with relevant proper nouns. Remove phrases like “based on the given passage/information . . . ” by making it a does or what or how or why question. Remove phrases like “information provided . . . ” by making it a does or what or how or why question. Remove mentions of any passage, information, context, etc.

Old_Question: {question}
<Passage>
The following information is from a file with the title “{file_name}”.
{passage}
</Passage>
Answer Format - Generate a JSON with the following fields
“New_Question”: <Fill with new question>

The example input includes instructions 236 of “Your task is to make minor edits to Old_Question if needed to make it sound “Natural”. Replace generic pronouns with relevant proper nouns. Remove phrases like “based on the given passage/information . . . ” by making it a does or what or how or why question. Remove phrases like “information provided . . . ” by making it a does or what or how or why question. Remove mentions of any passage, information, context, etc.” The input includes placeholders of “{question}” and “{passage}” to denote a respective question and portion 230 of content 202. The example input specifies that the output of the machine learning model should include be in JSON format and include a “New_Question” field that is populated with the rewritten question.

After tone rewrite 228 has been used to transform the deduplicated and relevance-filtered questions 222, data-generation pipeline 122 applies a tone filter 248 to the transformed questions 222. In one or more embodiments, tone filter 248 is used to identify transformed questions 222 that do not sound human-generated. To implement tone filter 248, data-generation pipeline 122 inputs (i) a given portion 230 of content 202, (ii) a question generated for that portion 230 of content 202, and (iii) a prompt that includes one or more instructions 236 and/or one or more reasoning structures 238 into an LLM and/or another machine learning model. In response to the input, the machine learning model generates output that includes a rephrasing of the question according to criteria specified in the prompt.

For example, input into a machine learning model that is used to apply tone filter 248 may include the following representation:
Your task is to figure out if a question was written by a human or a robot.

Question: {question}
<Passage>
The following information is from a file with the title “{file_name}”.
{passage}
</Passage>
Answer Format - Generate a JSON with the following fields
“Human_or_Robot”: <Fill with Human or Robot>

The example input includes instructions 236 of “Your task is to figure out if a question was written by a human or a robot.” The input includes placeholders of “{question}” and “{passage}” to denote a respective question and portion 230 of content 202. The example input specifies that the output of the machine learning model should be in JSON format and include a “Human_or_Robot” field that is populated with the outcome of tone filter 248 (e.g., either “human” or “robot”). Any question that is identified by the machine learning model as written by a robot may be filtered.

Data-generation pipeline 122 also applies a nuance filter 240 to questions 222 that pass tone filter 248. In some embodiments, nuance filter 240 is used to identify general knowledge, straightforward, and/or “fact-based” questions 222 that can be answered by “looking up” details from the corresponding portions 230 of content 202. To implement nuance filter 240, data-generation pipeline 122 inputs (i) a given portion 230 of content 202, (ii) a question generated for that portion 230 of content 202, and (iii) a prompt that includes one or more instructions 236 and/or one or more reasoning structures 238 into an LLM and/or another machine learning model. In response to the input, the machine learning model generates output that includes a rephrasing of the question according to criteria specified in the prompt.

For example, input into a machine learning model that is used to apply nuance filter 240 may include the following representation:
You are an irritated teacher. Classify a student's question into the following types.
   Type_A: The question can be answered with information evidently present in the Passage.
   Type_B: Answer is not directly present in the passage but can be obtained by reasoning on the information.
   Type_C: The question can only be partly answered using the information in the Passage. This includes cases where the passage points to other evidence that is required to answer the question.
   Type_D: The passage doesn't have enough information to answer the question.

Question: {question}
<Passage>
The following information is from a file with the title “{file_name}”.
{passage}
</Passage>
Answer Format - Generate a JSON with the following fields
“Type_of_question”: <Fill with Type_A or Type_B or Type_C or
Type_D>

The example input includes instructions 236 of “You are an irritated teacher. Classify a student's question into the following types” followed by descriptions of four types of questions. The input also includes placeholders of “{question}” and “{passage}” to denote a respective question and portion 230 of content 202. The example input specifies that the output of the machine learning model should be in JSON format and include a “Type_of_question” field that is populated with one of the four types of questions. Any question that is identified by the machine learning model as belonging to one or more of these types (e.g., all types other than “Type_B” and/or “Type_C”) may be filtered.

After nuance filter 240 has been applied, data-generation pipeline 122 obtains a set of base questions 254 as the output of filtering stage 212. These base questions 254 include questions 222 that have passed through question deduplication 224, relevance filter 226, tone rewrite 228, tone filter 248, and nuance filter 240.

Data-generation pipeline 122 also uses base questions 254 as input into variant-generation stage 214. During variant-generation stage 214, data-generation pipeline 122 performs a persona rewrite 256 that converts each of base questions 254 into a larger number of question variants 258.

To perform persona rewrite 256, data-generation pipeline 122 inputs (i) attributes 232 associated with a given persona, (ii) a question from the set of base questions 254, and (iii) a prompt that includes one or more instructions 236 and/or one or more reasoning structures 238 into an LLM and/or another machine learning model. In response to the input, the machine learning model generates output that includes a rephrasing of the question in a manner that is consistent with the persona.

For example, input into a machine learning model that is used to perform persona rewrite 256 may include the following representation:
Your task is to behave like the Persona mentioned below. With this persona in mind, re-enact how you would ask a question mentioned below. Don't assume any relation between the persona and the question.

<Persona>
{persona}
</Persona>
Question: {question}
Answer Format - Generate a JSON with the following fields
“New_Question”: <fill with the new question>

Try creative thinking, generate innovative and out-of-the-box ideas to solve the problem. Explore unconventional solutions, thinking beyond traditional boundaries, and encouraging imagination and originality.

The example input includes instructions 236 of “Your task is to behave like the Persona mentioned below. With this persona in mind, re-enact how you would ask a question mentioned below. Don't assume any relation between the persona and the question.” The input also includes placeholders of “{question}” and “{persona}” to denote a question and attributes 232 of a given persona, respectively. The example input specifies that the output of the machine learning model should be in JSON format and include a “New_Question” field that is populated with the rewritten question. The example input additionally includes a reasoning structure of “Try creative thinking, generate innovative and out-of-the-box ideas to solve the problem. Explore unconventional solutions, thinking beyond traditional boundaries, and encouraging imagination and originality.”

The operation of data-generation pipeline 122 can be illustrated with the following example portion 230 of content 202:
“title”: “Autumn”,
“text”: “Some cultures regard the autumnal equinox as \“mid-autumn\”, while others with a longer temperature lag treat it as the start of autumn. Meteorologists (and most of the temperate countries in the southern hemisphere) use a definition based on Gregorian calendar months, with autumn being September, October, and November in the northern hemisphere, and March, April, and May in the southern hemisphere.

Using this portion 230 of content 202, data-generation pipeline 122 produces the following synthetic question variants 258:
So, how do people from different cultures and weather experts see autumn differently, like, what's their unique take on it?
Are the months of March, April, and May considered autumn in the southern hemisphere?
Does the autumnal equinox hold cultural significance as the midpoint of autumn?
   Each question variant includes a different point of interest (e.g., views on autumn, when autumn occurs in the southern hemisphere, the cultural significance of autumn), communication and/or writing style, and/or levels of nuance (e.g., a fact-based question about when autumn occurs in the southern hemisphere vs. nuanced questions about the semantic content of portion 230 that do not mirror the terminology in portion 230).

In one or more embodiments, data-generation pipeline 122 includes functionality to vary the generation of question variants 258 across base questions 254 and/or personas 204. For example, data-generation pipeline 122 may use persona rewrite 256 to generate, from one question, k question variants 258 for each of l personas 204 for a total of k×l question variants 258 of that question. Data-generation pipeline 122 may then repeat the process for additional questions in the set of base questions 254. Data-generation pipeline 122 may also, or instead, convert a given question into a different number of question variants 258 for each persona, use different sets of personas 204 to generate question variants 258 for different questions, and/or otherwise vary the generation of question variants 258 across different base questions 254.

As discussed herein, management engine 124 and data-generation pipeline 122 may incorporate Self-Discover techniques to generate and/or adapt reasoning structures 238 to various tasks within question-generation stage 210, filtering stage 212, and/or variant-generation stage 214. Similarly, management engine 124 and/or data-generation pipeline 122 may use a critic loop to evaluate some or all output generated by LLMs, VLMs, multi-modal language models, and/or other types of language models used to perform these tasks. For example, output (e.g., points of interest 216, POI-question type mappings 220, questions 222, tone rewrite 228, filters, question variants 258, etc.) generated by a given language model during execution of data-generation pipeline 122 may be evaluated using a different language model that is prompted to act as a “critic.” The output of the critic may then be fed back into the original language model as feedback that is used to regenerate and/or refine the output of the original language model. The process may be repeated to improve the output of the original language model before the output is further processed (e.g., by a subsequent task and/or stage of data-generation pipeline 122) and/or used by execution engine 126 to perform evaluation 242, fine-tuning 244, and/or retrieval 246.

While the operation of data-generation pipeline 122 has been discussed above with respect to a specific ordering of stages and/or operations within each stage, it will be appreciated that data-generation pipeline 122 may generate questions using a different set of stages, a different set of operations within each stage, a different ordering of stages, and/or a different ordering of operations within each stage. For example, data-generation pipeline 122 may apply various filters to points of interest 216, questions 222, base questions 254, and/or question variants 258. In another example, data-generation pipeline 122 may rewrite questions 222, base questions 254, and/or question variants 258 based on (but not limited to) tone, personas 204, relevance to the corresponding portions 230 of content 202, and/or other criteria. In a third example, data-generation pipeline 122 may perform deduplication of various types of data generated by data-generation pipeline 122 before additional processing is performed using the data. In a fourth example, data-generation pipeline 122 may omit, reorder, add, and/or modify stages and/or operations within each stage to tailor the generation of synthetic questions to available resources, a “target” number of questions, a “target” coverage of content 202 by the generated questions, and/or other priorities or constraints.

Execution engine 126 incorporates question variants 258 and/or other data outputted by data-generation pipeline 122 into various use cases associated with retrieval of content 202. First, execution engine 126 may use question variants 258 paired with the corresponding portions 230 of content 202 to perform evaluation 242 of embedding models and/or other components involved in retrieving content in response to a query and/or prompt. For example, execution engine 126 may use an embedding model to convert each portion 230 of content 202 and all question variants 258 generated for that portion 230 of content into embeddings. Execution engine 126 may also determine the performance of the embedding model based on whether an embedding of a given question variant results in the retrieval (e.g., using a vector database and/or RAG workflow) of the corresponding portion 230 of content 202, the embedding of the question is within a threshold distance of the embedding for the corresponding portion 230 of content 202, the embedding of the question is included in a certain number of the closest embeddings to the embedding for the corresponding portion 230 of content 202, and/or other performance criteria.

Execution engine 126 may also, or instead, perform fine-tuning 244 of the embedding models and/or components. For example, execution engine 126 may generate positive pairs of training data from question variants 258 and the corresponding portions 230 of content 202. Execution engine 126 may additionally generate negative pairs of training data from question variants 258 and portions 230 of content 202 that were not used to generate these question variants 258. Execution engine 126 may then train an embedding model using the positive and negative pairs of training data and a contrastive loss, triplet loss, magnet loss, and/or another type of loss that (i) reduces distances between question variants 258 and corresponding portions 230 of content and/or between question variants 258 associated with the same portion 230 of content 202 and (ii) increases distances between question variants 258 and portions 230 of content 202 that were not used to generate these question variants 258 and/or between question variants 258 associated with different portions 230 of content 202.

Execution engine 126 may also, or instead, perform retrieval 246 of content 202 using question variants 258. For example, execution engine 126 may use an embedding model that has been trained and/or fine-tuned using question variants 258 and the corresponding portions 230 of content 202 to generate an embedding of a user-generated prompt to an LLM, match the embedding to embeddings of portions of content (e.g., portions 230 of content 202 and/or additional portions of content that were not used in the generation of question variants 258), and provide the portions of content as additional input into the LLM. In another example, execution engine 126 may supplement a RAG workflow by matching an embedding of a prompt for an LLM to additional embeddings of question variants 258. Execution engine 126 may then use the additional embeddings to retrieve and provide corresponding portions 230 of content 202 and/or other portions of content that were not used in the generation of question variants 258 as additional input into the LLM.

While the operation of data-generation pipeline 122, management engine 124, and execution engine 126 has been described with respect to improving retrieval of text-based content 202 based on text-based questions, it will be appreciated that the functionality of data-generation pipeline 122, management engine 124, and execution engine 126 may be adapted to other types of content 202 and/or types of retrieval. For example, data-generation pipeline 122, management engine 124, and execution engine 126 may be used to evaluate and/or improve the retrieval and/or use of images, audio, video, biochemical data, sensor data, medical data, three-dimensional (3D) data (e.g., computer aided design (CAD) data, USD data (e.g., for NVIDIA's OMNIVERSE or other collaborative content generation/sharing/interactive platforms, etc.), and/or other types of content 202 using multi-modal embedding models, vision language models, and/or other components based on input that includes the same types of content and/or other types of content.

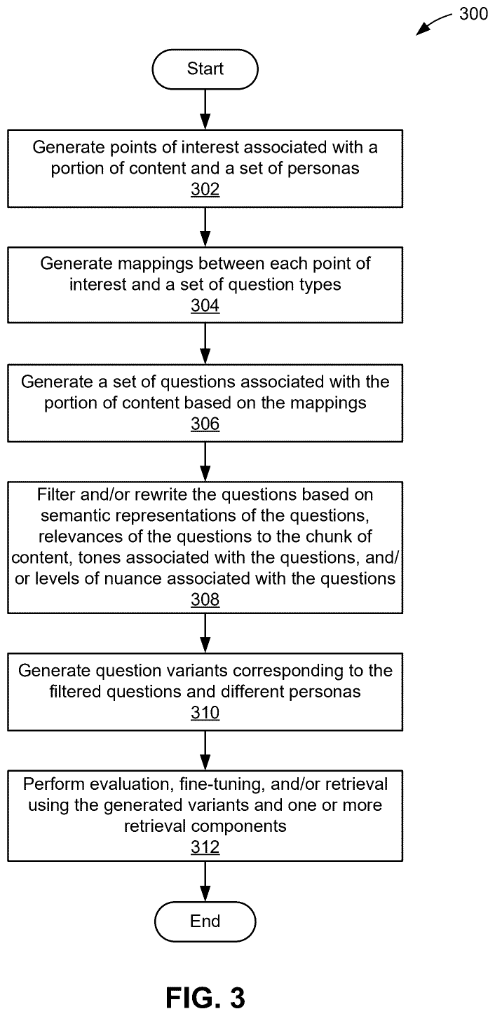

Now referring to FIG. 3, each block of method 300, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 300 is described, by simulated way of example, with respect to the systems of FIGS. 1-2. However, these methods may additionally or alternatively be executed by any one system, or any combination of systems, including, but not limited to, those described herein. Further, the operations in method 300 may be omitted, repeated, and/or performed in any order without departing from the scope of the present disclosure.

FIG. 3 illustrates a flow diagram of a method 300 for generating synthetic questions from content, according to at least one embodiment. As shown in FIG. 3, method 300 begins with operation 302, in which data-generation pipeline 122 and management engine 124 generate points of interest associated with a portion of content and a set of personas. For example, management engine 124 may generate input that includes a passage of text and/or another portion of content, descriptions of attributes for the set of personas, and a prompt that includes instructions for generating the points of interest and/or a reasoning structure used to generate the points of interest. Data-generation pipeline 122 may provide the input to an LLM and/or another type of machine learning model and obtain the points of interest as corresponding output of the machine learning model. Each point of interest may correspond to a topic, theme, sentiment, and/or another entity that is associated with the chunk of content and determined to be of interest to one or more personas. Data-generation pipeline 122 may also deduplicate the points of interest based on embeddings and/or other semantic representations of the points of interest.

In operation 304, data-generation pipeline 122 and management engine 124 generate mappings between each point of interest and a set of question types. For example, management engine 124 may generate input that includes a given point of interest, the portion of content, descriptions of the question types, and a prompt that includes instructions for generating the mappings and/or a reasoning structure used to generate the mappings. Data-generation pipeline 122 may provide the input to an LLM and/or another type of machine learning model and obtain a list of question types associated with the point of interest as corresponding output of the machine learning model. Management engine 124 and data-generation pipeline 122 may repeat the process for additional points of interest to generate a different set of mappings between each point of interest and a corresponding set of question types.

In operation 306, data-generation pipeline 122 and management engine 124 generate a set of questions associated with the portion of content based on the mappings. For example, management engine 124 may generate input that includes the portion of content, a point of interest, a set of question types mapped to the point of interest, and a prompt that includes instructions for generating the questions and/or a reasoning structure used to generate the questions. Data-generation pipeline 122 may provide the input to an LLM and/or another type of machine learning model and obtain a list of questions associated with the point of interest, question types, and portion of content as corresponding output of the machine learning model. Management engine 124 and data-generation pipeline 122 may repeat the process for additional points of interest and question types mapped to the points of interest to generate a different set of questions for each point of interest.

In operation 308, data-generation pipeline 122 and management engine 124 filter and/or rewrite the generated questions based on semantic representations of the questions, relevances of the questions to the chunk of content, tones associated with the questions, and/or levels of nuance associated with the questions. For example, data-generation pipeline 122 may deduplicate the questions based on embeddings and/or other semantic representations of the questions. Data-generation pipeline 122 and management engine 124 may also use prompts and/or other input into LLMs and/or other machine learning models to identify and/or filter questions that are not relevant to the portion of content, rewrite the questions to have a more conversational tone, identify and/or filter questions that do not sound human-generated, identify and/or filter questions that are below a threshold level of nuance, and/or otherwise filter and/or transform the questions.

In operation 310, data-generation pipeline 122 and management engine 124 generate question variants corresponding to the filtered questions and different personas. For example, management engine 124 may generate input that includes a question, a persona, an instruction to rewrite the question in a way that reflects the persona, and/or a reasoning structure for rewriting the question. Data-generation pipeline 122 may provide the input to an LLM and/or another type of machine learning model and obtain a new question that corresponds to a rephrasing of the inputted question to match the persona as corresponding output of the machine learning model. Management engine 124 and data-generation pipeline 122 may repeat the process for additional pairs of questions and personas.

In operation 312, execution engine 126 performs evaluation, fine-tuning, and/or retrieval using the generated variants and one or more retrieval components. For example, execution engine 126 may use the generated question variants to assess the performance of an embedding model, vector database, and/or other components of a RAG workflow in matching questions to the corresponding chunks of content. In another example, execution engine 126 may fine-tune an embedding model using a training dataset that includes positive pairs of questions and portions of content used to generate the questions and negative pairs of questions and portions of content that were not used to generate the questions. Execution engine 126 may also, or instead, use the fine-tuned embedding model to generate an embedding of a user-generated prompt for an LLM, match the embeddings to additional embeddings of portions of content (e.g., using a vector database), and provide the portions of content as additional input to an LLM during processing of the user-generated prompt by the LLM.

In sum, the disclosed techniques generate synthetic data that can be used to evaluate and/or improve the retrieval of content based on a prompt and/or other input. This synthetic data may include a diverse and customizable set of synthetic questions that are relevant to different portions of content and reflect a variety of user demographics, interests, communication styles, and/or backgrounds.

A multi-stage pipeline is used to generate the synthetic questions using a set of content and a set of user personas. Each stage in the multi-stage pipeline may be implemented using prompts to LLMs and/or embedding models. The pipeline includes a first stage that identifies points of interest within different portions of the content based on descriptions of various user personas, including (but not limited to) communication styles, interests, backgrounds, levels of knowledge, habits, and/or other characteristics of each user persona. Each point of interest represents a topic, theme, sentiment, and/or another entity that is associated with a corresponding portion of content (e.g., a passage from a document) and determined to be of interest to one or more user personas. The first stage also maps these points of interest to different types of questions (e.g., extractive, abstractive, aggregative, etc.) that can be asked and uses the mappings between the points of interest and types of questions are to generate a comprehensive set of potential questions that can be asked of the portion of content.

The pipeline also includes a second stage that applies various filters to the generated questions. These filters may be used to remove semantically duplicated questions, questions that cannot be answered using corresponding portions of content, robotic-sounding questions, general knowledge questions, and/or other types of questions with attributes that are determined to be “undesirable” for the purposes of evaluating and/or improving the retrieval of content. These filters may also, or instead, be used to rephrase questions to be more conversational and/or less formal.

The pipeline additionally includes a third stage that generates variants of the filtered questions. This stage involves prompting an LLM to convert a given question into a variant that reflects the style and/or tone of a given persona. Questions generated by the pipeline may then be paired with the corresponding portions of content and used to evaluate and/or fine-tune embedding models, RAG implementations, and/or LLMs in answering questions using retrieved content.

One technical advantage of the disclosed techniques relative to prior approaches is the ability to generate, filter, and/or rewrite a diverse set of synthetic questions in a way that is tailored to different types of content and/or the nuances, interests, communication styles, and/or backgrounds of a set of customizable user personas. Consequently, the disclosed techniques allow embedding models, LLMs, and/or other components of RAG workflows to be evaluated and/or fine-tuned more thoroughly than conventional approaches that generate questions that are robotic, formulaic, and/or narrow in scope. Additionally, the customization of the generated questions to different types of content, personas, types of questions, and/or attributes of questions allow the evaluation and/or fine-tuning of RAG components to be targeted toward different use cases, purposes, and/or priorities. Further, because the generated questions are filtered, deduplicated, and/or rewritten without adversely impacting the diversity of the generated questions, the disclosed techniques can be used to generate a synthetic dataset that is diverse, balanced, and representative of user-generated input into LLMs. The disclosed techniques may thus improve resource overhead and/or retrieval performance compared with conventional approaches that use less diverse, unique, and/or balanced questions to evaluate and/or fine-tune RAG components.

### Inference and Training Logic

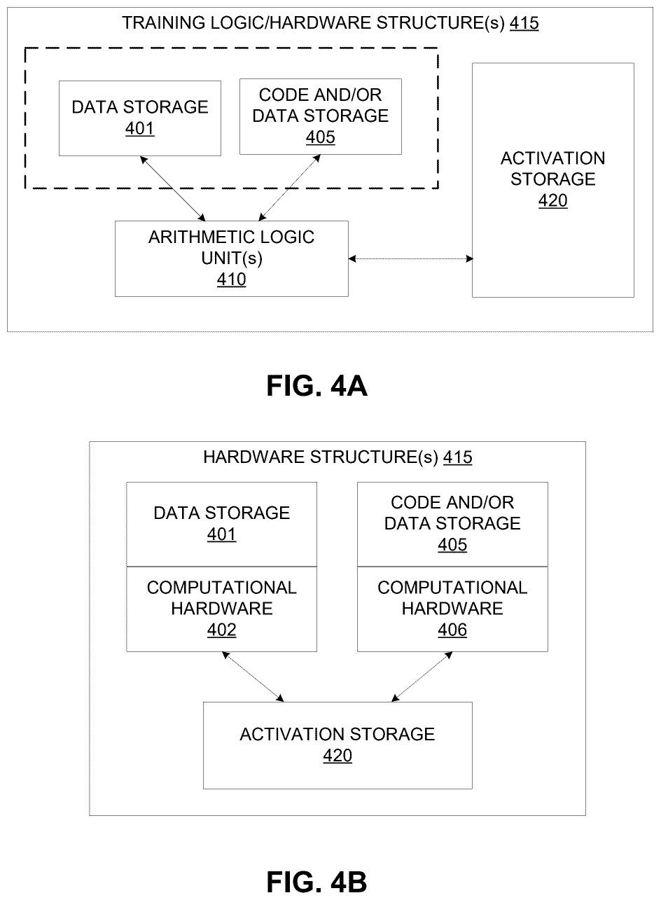

FIG. 4A illustrates inference and/or training logic 415 used to perform inferencing and/or training operations associated with one or more embodiments. Details regarding inference and/or training logic 415 are provided herein in conjunction with at least FIGS. 4A and/or 4B.

In at least one embodiment, inference and/or training logic 415 may include, without limitation, code and/or data storage 401 to store forward and/or output weight and/or input/output data, and/or other parameters to configure neurons or layers of a neural network trained and/or used for inferencing in aspects of one or more embodiments. In at least one embodiment, training logic 415 may include, or be coupled to code and/or data storage 401 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 401 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 401 may be included with other on-chip or off-chip data storage, including a processor's L1, L2, or L3 cache or system memory.

In at least one embodiment, any portion of code and/or data storage 401 may be internal or external to one or more processors or other hardware logic devices or circuits. In at least one embodiment, code and/or code and/or data storage 401 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 401 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 415 may include, without limitation, a code and/or data storage 405 to store backward and/or output weight and/or input/output data corresponding to neurons or layers of a neural network trained and/or used for inferencing in aspects of one or more embodiments. In at least one embodiment, code and/or data storage 405 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 415 may include, or be coupled to code and/or data storage 405 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 405 may be included with other on-chip or off-chip data storage, including a processor's L1, L2, or L3 cache or system memory. In at least one embodiment, any portion of code and/or data storage 405 may be internal or external to one or more processors or other hardware logic devices or circuits. In at least one embodiment, code and/or data storage 405 may be cache memory, DRAM, SRAM, non-volatile memory (e.g., flash memory), or other storage. In at least one embodiment, a choice of whether code and/or data storage 405 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 401 and code and/or data storage 405 may be separate storage structures. In at least one embodiment, code and/or data storage 401 and code and/or data storage 405 may be a combined storage structure. In at least one embodiment, code and/or data storage 401 and code and/or data storage 405 may be partially combined and partially separate. In at least one embodiment, any portion of code and/or data storage 401 and code and/or data storage 405 may be included with other on-chip or off-chip data storage, including a processor's L1, L2, or L3 cache or system memory.

In at least one embodiment, inference and/or training logic 415 may include, without limitation, one or more arithmetic logic unit(s) (“ALU(s)”) 410, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 420 that are functions of input/output and/or weight parameter data stored in code and/or data storage 401 and/or code and/or data storage 405. In at least one embodiment, activations stored in activation storage 420 are generated according to linear algebraic and or matrix-based mathematics performed by ALU(s) 410 in response to performing instructions or other code, wherein weight values stored in code and/or data storage 405 and/or data storage 401 are used as operands along with other values, such as bias values, gradient information, momentum values, or other parameters or hyperparameters, any or all of which may be stored in code and/or data storage 405 or code and/or data storage 401 or another storage on or off-chip.

In at least one embodiment, ALU(s) 410 are included within one or more processors or other hardware logic devices or circuits, whereas in another embodiment, ALU(s) 410 may be external to a processor or other hardware logic device or circuit that uses them (e.g., a coprocessor). In at least one embodiment, ALUs 410 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 401, code and/or data storage 405, and activation storage 420 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 420 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 420 may be cache memory, DRAM, SRAM, non-volatile memory (e.g., flash memory), or other storage. In at least one embodiment, activation storage 420 may be completely or partially within or external to one or more processors or other logical circuits. In at least one embodiment, a choice of whether activation storage 420 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 415 illustrated in FIG. 4A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 415 illustrated in FIG. 4A may be used in conjunction with central processing unit (“CPU”) hardware, graphics processing unit (“GPU”) hardware or other hardware, such as field programmable gate arrays (“FPGAs”).

FIG. 4B illustrates inference and/or training logic 415, according to at least one embodiment. In at least one embodiment, inference and/or training logic 415 may include, without limitation, hardware logic in which computational resources are dedicated or otherwise exclusively used in conjunction with weight values or other information corresponding to one or more layers of neurons within a neural network. In at least one embodiment, inference and/or training logic 415 illustrated in FIG. 4B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 415 illustrated in FIG. 4B may be used in conjunction with central processing unit (CPU) hardware, graphics processing unit (GPU) hardware or other hardware, such as field programmable gate arrays (FPGAs). In at least one embodiment, inference and/or training logic 415 includes, without limitation, code and/or data storage 401 and code and/or data storage 405, which may be used to store code (e.g., graph code), weight values and/or other information, including bias values, gradient information, momentum values, and/or other parameter or hyperparameter information. In at least one embodiment illustrated in FIG. 4B, each of code and/or data storage 401 and code and/or data storage 405 is associated with a dedicated computational resource, such as computational hardware 402 and computational hardware 406, respectively. In at least one embodiment, each of computational hardware 402 and computational hardware 406 comprises one or more ALUs that perform mathematical functions, such as linear algebraic functions, only on information stored in code and/or data storage 401 and code and/or data storage 405, respectively, result of which is stored in activation storage 420.

In at least one embodiment, each of code and/or data storage 401 and 405 and corresponding computational hardware 402 and 406, respectively, correspond to different layers of a neural network, such that resulting activation from one storage/computational pair 401/402 of code and/or data storage 401 and computational hardware 402 is provided as an input to a next storage/computational pair 405/406 of code and/or data storage 405 and computational hardware 406, in order to mirror a conceptual organization of a neural network. In at least one embodiment, each of storage/computational pairs 401/402 and 405/406 may correspond to more than one neural network layer. In at least one embodiment, additional storage/computation pairs (not shown) subsequent to or in parallel with storage/computation pairs 401/402 and 405/406 may be included in inference and/or training logic 415.

### Neural Network Training and Deployment

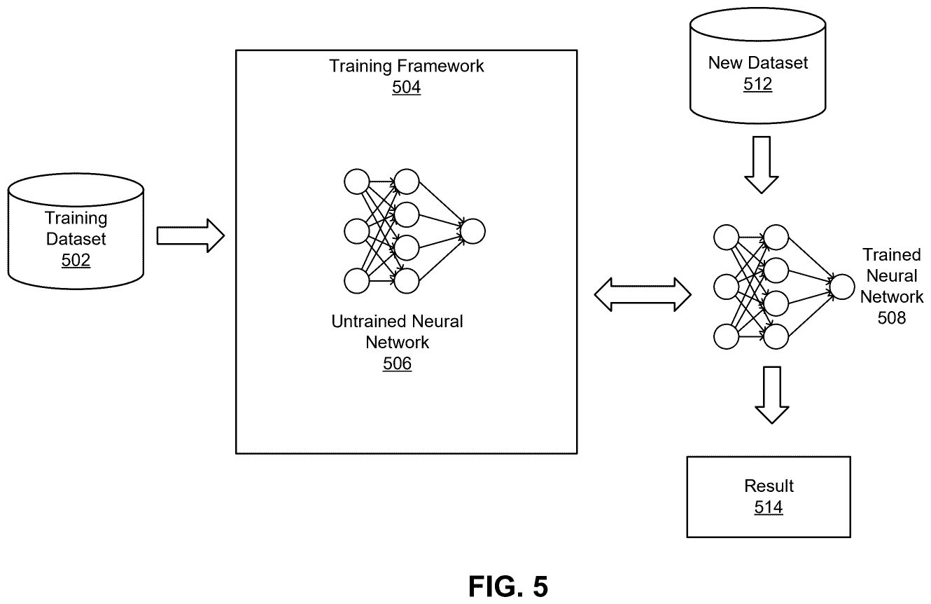

FIG. 5 illustrates training and deployment of a deep neural network, according to at least one embodiment. In at least one embodiment, untrained neural network 506 is trained using a training dataset 502. In at least one embodiment, training framework 504 is a PyTorch framework, whereas in other embodiments, training framework 504 is a TensorFlow, Boost, Caffe, Microsoft Cognitive Toolkit/CNTK, MXNet, Chainer, Keras, Deeplearning4j, or other training framework. In at least one embodiment, training framework 504 trains an untrained neural network 506 and enables it to be trained using processing resources described herein to generate a trained neural network 508. In at least one embodiment, weights may be chosen randomly or by pre-training using a deep belief network. In at least one embodiment, training may be performed in either a supervised, partially supervised, or unsupervised manner.

In at least one embodiment, untrained neural network 506 is trained using supervised learning, wherein training dataset 502 includes an input paired with a desired output for an input, or where training dataset 502 includes input having a known output and an output of neural network 506 is manually graded. In at least one embodiment, untrained neural network 506 is trained in a supervised manner and processes inputs from training dataset 502 and compares resulting outputs against a set of expected or desired outputs. In at least one embodiment, errors are then propagated back through untrained neural network 506. In at least one embodiment, training framework 504 adjusts weights that control untrained neural network 506. In at least one embodiment, training framework 504 includes tools to monitor how well untrained neural network 506 is converging towards a model, such as trained neural network 508, suitable to generating correct answers, such as in result 514, based on input data such as a new dataset 512. In at least one embodiment, training framework 504 trains untrained neural network 506 repeatedly while adjust weights to refine an output of untrained neural network 506 using a loss function and adjustment algorithm, such as stochastic gradient descent. In at least one embodiment, training framework 504 trains untrained neural network 506 until untrained neural network 506 achieves a desired accuracy. In at least one embodiment, trained neural network 508 can then be deployed to implement any number of machine learning operations.

In at least one embodiment, untrained neural network 506 is trained using unsupervised learning, wherein untrained neural network 506 attempts to train itself using unlabeled data. In at least one embodiment, unsupervised learning training dataset 502 will include input data without any associated output data or “ground truth” data. In at least one embodiment, untrained neural network 506 can learn groupings within training dataset 502 and can determine how individual inputs are related to untrained dataset 502. In at least one embodiment, unsupervised training can be used to generate a self-organizing map in trained neural network 508 capable of performing operations useful in reducing dimensionality of new dataset 512. In at least one embodiment, unsupervised training can also be used to perform anomaly detection, which allows identification of data points in new dataset 512 that deviate from normal patterns of new dataset 512.

In at least one embodiment, semi-supervised learning may be used, which is a technique in which in training dataset 502 includes a mix of labeled and unlabeled data. In at least one embodiment, training framework 504 may be used to perform incremental learning, such as through transferred learning techniques. In at least one embodiment, incremental learning enables trained neural network 508 to adapt to new dataset 512 without forgetting knowledge instilled within trained neural network 508 during initial training.

In at least one embodiment, training framework 504 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, OpenVINO supports neural networks such as convolutional neural networks (CNNs), recurrent and/or attention-based neural networks, and/or various other neural network models. In at least one embodiment, OpenVINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, OpenVINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, OpenVINO provides various software functions to execute a program on one or more devices. In at least one embodiment, OpenVINO provides various software functions to execute a program and/or portions of a program on different devices. In at least one embodiment, OpenVINO provides various software functions to, for example, run a first portion of code on a CPU and a second portion of code on a GPU and/or FPGA. In at least one embodiment, OpenVINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets, systems implemented at least partially using cloud computing resources, and/or other types of systems.

### Example Language Models

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs—such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

FIG. 6A is a block diagram of an example generative language model system 600 suitable for use in implementing at least some embodiments of the present disclosure. In the example illustrated in FIG. 6A, the generative language model system 600 includes a retrieval augmented generation (RAG) component 692, an input processor 605, a tokenizer 610, an embedding component 620, plug-ins/APIs 695, and a generative language model (LM) 630 (which may include an LLM, a VLM, a multi-modal LM, etc.).

At a high level, the input processor 605 may receive an input 601 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 630. In some embodiments, the input 601 includes plain text in the form of one or more sentences, paragraphs, and/or documents. Additionally or alternatively, the input 601 may include numerical sequences, precomputed embeddings (e.g., word or sentence embeddings), and/or structured data (e.g., in tabular formats, JSON, or XML). In some implementations in which the generative LM 630 is capable of processing multimodal inputs, the input 601 may combine text with image data, audio data, and/or other types of input data, such as but not limited to those described herein. Taking raw input text as an example, the input processor 605 may prepare raw input text in various ways. For example, the input processor 605 may perform various types of text cleaning to remove noise (e.g., special characters, punctuation, HTML tags, stopwords) from relevant textual content. In an example involving stopwords (common words that tend to carry little semantic meaning), the input processor 605 may remove stopwords to reduce noise and focus the generative LM 630 on more meaningful content. The input processor 605 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 692 may be used to retrieve additional information to be used as part of the input 601 or prompt. For example, in some embodiments, the input 601 may be generated using the query or input to the model (e.g., a question, a request, etc.) in addition to data retrieved using the RAG component 692. In some embodiments, the input processor 605 may analyze the input 601 and communicate with the RAG component 692 (or the RAG component 692 may be part of the input processor 605, in embodiments) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 may retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 692 may retrieve a prior stored conversation history—or at least a summary thereof—and include the prior conversation history along with the current ask/request as part of the input 601 to the generative LM 630.

The tokenizer 610 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy may depend on factors such as the language being processed, the task at hand, and/or characteristics of the training dataset. As such, the tokenizer 610 may convert the (e.g., processed) text into a structured format according to tokenization schema being implemented in the particular embodiment.

The embedding component 620 may use any known embedding technique to transform discrete tokens into (e.g., dense, continuous vector) representations of semantic meaning. For example, the embedding component 620 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data, the input processor 601 may resize the image data to a standard size compatible with format of a corresponding input channel and/or may normalize pixel values to a common range (e.g., 0 to 1) to ensure a consistent representation, and the embedding component 620 may encode the image data using any known technique (e.g., using one or more convolutional neural networks (CNNs) to extract visual features). In some implementations in which the input 601 includes audio data, the input processor 601 may resample an audio file to a consistent sampling rate for uniform processing, and the embedding component 620 may use any known technique to extract and encode audio features—such as in the form of a spectrogram (e.g., a mel-spectrogram). In some implementations in which the input 601 includes video data, the input processor 601 may extract frames or apply resizing to extracted frames, and the embedding component 620 may extract features such as optical flow embeddings or video embeddings and/or may encode temporal information or sequences of frames. In some implementations in which the input 601 includes multimodal data, the embedding component 620 may fuse representations of the different types of data (e.g., text, image, audio) using techniques like early fusion (concatenation), late fusion (sequential processing), attention-based fusion, etc.

The generative LM 630 and/or other components of the generative LLM system 600 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 620 may apply an encoded representation of the input 601 to the generative LM 630, and the generative LM 630 may process the encoded representation of the input 601 to generate an output 690, which may include responsive text and/or other types of data.

As described herein, in some embodiments, the generative LM 630 may be configured to access or use—or capable of accessing or using—plug-ins/APIs 695 (which may include one or more plug-ins, application programming interfaces (APIs), databases, data stores, repositories, etc.). For example, for certain tasks or operations that the generative LM 630 is not ideally suited for, the model may have instructions (e.g., as a result of training, and/or based on instructions in a given prompt, such as those retrieved using the RAG component 692) to access one or more plug-ins/APIs 695 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 695 to the plug-in/API 695, the plug-in/API 695 may process the information and return an answer to the generative LM 630, and the generative LM 630 may use the response to generate the output 690. This process may be repeated—e.g., recursively—for any number of iterations and using any number of plug-ins/APIs 695 until an output 690 that addresses each ask/question/request/process/operation/etc. from the input 601 can be generated. As such, the model(s) may not only rely on its own knowledge from training on a large dataset(s) and/or from data retrieved using the RAG component 692, but also on the expertise or optimized nature of one or more external resources—such as the plug-ins/APIs 695.

FIG. 6B is a block diagram of an example implementation in which the generative LM 630 includes a transformer encoder-decoder. For example, assume input text such as “Who discovered gravity” is tokenized (e.g., by the tokenizer 610 of FIG. 6A) into tokens such as words, and each token is encoded (e.g., by the embedding component 620 of FIG. 6A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 635 of the generative LM 630.

In an example implementation, the encoder(s) 635 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 640 may convert the context vector into attention vectors (keys and values) for the decoder(s) 645.

In an example implementation, the decoder(s) 645 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 635, in an example transformer architecture, each token (e.g., word) flows through a separate path in the decoder(s) 645. During a first pass, the decoder(s) 645, a classifier 650, and a generation mechanism 655 may generate a first token, and the generation mechanism 655 may apply the generated token as an input during a second pass. The process may repeat in a loop, successively generating and adding tokens (e.g., words) to the output from the preceding pass and applying the token embeddings of the composite sequence with positional encodings as an input to the decoder(s) 645 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 635, except that it creates its queries from the layer below it and takes the keys and values (e.g., matrix) from the output of the encoder(s) 635.

As such, the decoder(s) 645 may output some decoded (e.g., vector) representation of the input being applied during a particular pass. The classifier 650 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 655 may select or sample a word or token based on a corresponding predicted probability (e.g., select the word with the highest predicted probability) and append it to the output from a previous pass, generating each word or token sequentially. The generation mechanism 655 may repeat the process, triggering successive decoder inputs and corresponding predictions until selecting or sampling a symbol or token that represents the end of the response, at which point, the generation mechanism 655 may output the generated response.

FIG. 6C is a block diagram of an example implementation in which the generative LM 630 includes a decoder-only transformer architecture. For example, the decoder(s) 660 of FIG. 6C may operate similarly as the decoder(s) 645 of FIG. 6B except each of the decoder(s) 660 of FIG. 6C omits the encoder-decoder self-attention layer (since there is no encoder in this implementation). As such, the decoder(s) 660 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 660. As with the decoder(s) 645 of FIG. 6B, each token (e.g., word) may flow through a separate path in the decoder(s) 660, and the decoder(s) 660, a classifier 665, and a generation mechanism 670 may use auto-regression to sequentially generate one token at a time until predicting a symbol or token that represents the end of the response. The classifier 665 and the generation mechanism 670 may operate similarly as the classifier 650 and the generation mechanism 655 of FIG. 6B, with the generation mechanism 670 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

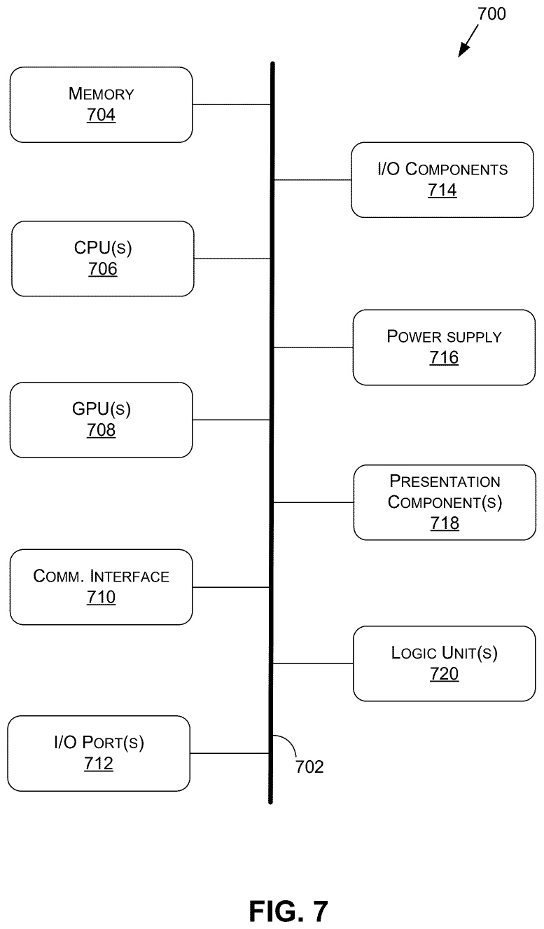

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. For example, the CPU(s) may be configured to execute one or more instances of data-generation pipeline 122, management engine 124, and/or execution engine 126. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

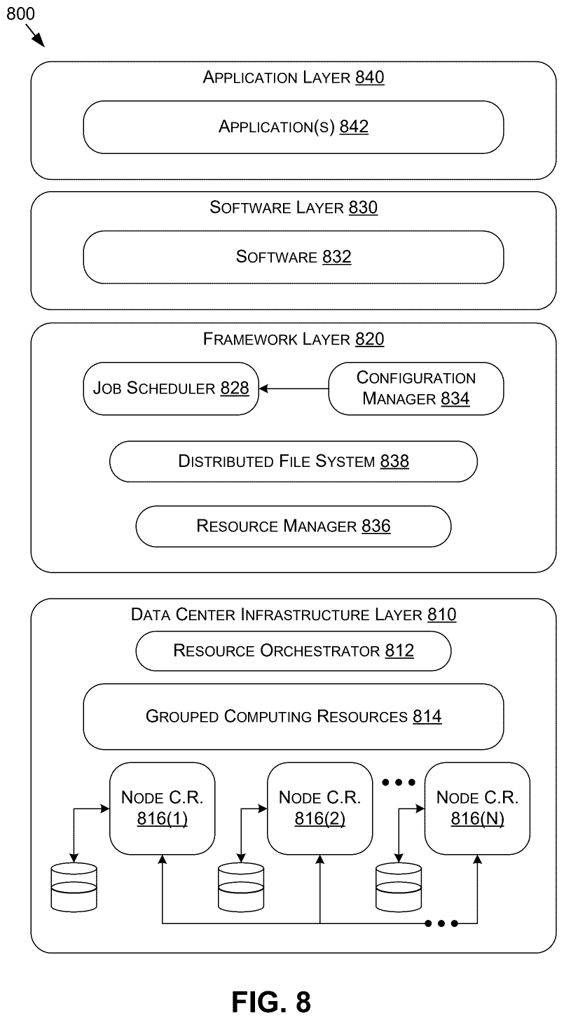

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software 832 may include, but are not limited to, Internet web page search software, e-mail virus scan software, database software, and streaming video content software. One or more types of software 832 may also, or instead, include data-generation pipeline 122, management engine 124, and/or execution engine 126.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Other variations are within spirit of present disclosure. Thus, while disclosed techniques are susceptible to various modifications and alternative constructions, certain illustrated embodiments thereof are shown in drawings and have been described herein in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating-point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously, or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

1. In some embodiments, a method comprises inputting a first prompt that includes (i) a first portion of content and (ii) a plurality of user personas into a first machine learning model; generating, via execution of the first machine learning model and based at least on the first prompt, a plurality of points of interest associated with the plurality of user personas and the first portion of content; inputting a second prompt that includes a plurality of mappings between the plurality of points of interest and a plurality of question types into a second machine learning model; generating, via execution of the second machine learning model and based at least on the second prompt, a plurality of questions associated with the plurality of user personas and the first portion of content; and retrieving a second portion of content based at least on the plurality of questions and a third prompt.

2. The method of clause 1, further comprising inputting a fourth prompt that includes (i) the plurality of points of interest and (ii) the plurality of question types into a third machine learning model; and generating, via execution of the third machine learning model and based at least on the fourth prompt, the plurality of mappings between the plurality of points of interest and the plurality of question types.

3. The method of any of clauses 1-2, further comprising generating a set of clusters associated with the plurality of points of interest; and deduplicating the plurality of points of interests based at least on the set of clusters prior to inputting the plurality of points of interest into the third machine learning model.

4. The method of any of clauses 1-3, wherein the set of clusters is generated based at least on a plurality of embeddings of the plurality of points of interest.

5. The method of any of clauses 1-4, further comprising filtering the plurality of questions based at least on at least one of semantic representations of the plurality of questions, relevances of the plurality of questions to the first portion of content, tones associated with the plurality of questions, or levels of nuance associated with the plurality of questions.

6. The method of any of clauses 1-5, wherein the generating the plurality of questions comprises converting, via execution of a third machine learning model, each question included in the plurality of questions into a plurality of question variants associated with the plurality of user personas.

7. The method of any of clauses 1-6, wherein the first prompt further includes a first instruction to generate the plurality of points of interest based at least on a first reasoning structure, and the second prompt further includes a second instruction to generate the plurality of questions based at least on a second reasoning structure.

8. The method of any of clauses 1-7, wherein the retrieving the second portion of content comprises updating one or more parameters of an embedding model based at least on training data that includes the plurality of questions paired with the first portion of content; generating, via the embedding model after the updating, (i) a first embedding of the third prompt and (ii) a second embedding of the second portion of content; and retrieving the second portion of content based at least on the first embedding and the second embedding.

9. The method of any of clauses 1-8, wherein the first machine learning model includes a large language model (LLM), a vision language model (VLM), or a multi-modal language model.

10. The method of any of clauses 1-9, wherein the plurality of user personas comprises at least one of a name, a role, a behavioral trait, an emotion, a demographic attribute, a communication style, a level of knowledge, a level of education, an attitude, a motivation, an interest, or a goal.

11. In some embodiments, at least one processor comprises processing circuitry to cause performance of operations comprising inputting a first prompt that includes (i) a first portion of content and (ii) a plurality of user personas into a first machine learning model; generating, via execution of the first machine learning model and based at least on the first prompt, a plurality of points of interest associated with the plurality of user personas and the first portion of content; inputting a second prompt that includes a plurality of mappings between the plurality of points of interest and a plurality of question types into a second machine learning model; generating, via execution of the second machine learning model and based at least on the second prompt, a plurality of questions associated with the plurality of user personas and the first portion of content; and retrieving a second portion of content based at least on the plurality of questions and a third prompt.

12. The at least one processor of clause 11, wherein the operations further comprise inputting a fourth prompt that includes (i) the plurality of points of interest and (ii) the plurality of question types into a third machine learning model; and generating, via execution of the third machine learning model and based at least on the fourth prompt, the plurality of mappings between the plurality of points of interest and the plurality of question types.

13. The at least one processor of any of clauses 11-12, wherein the generating the plurality of questions comprises converting, via execution of a third machine learning model, each question included in the plurality of questions into a plurality of question variants associated with the plurality of user personas.

14. The at least one processor of any of clauses 11-13, wherein the generating the plurality of questions further comprises generating a set of clusters associated with the plurality of questions; and deduplicating the plurality of questions based at least on the set of clusters prior to inputting the plurality of questions into the third machine learning model.

15. The at least one processor of any of clauses 11-14, wherein retrieving the second portion of content comprises generating, via an embedding model and based on the third prompt and the plurality of questions, (i) a first embedding of the third prompt and (ii) a second embedding of the second portion of content; and retrieving the second portion of content based at least on the first embedding and the second embedding.

16. The at least one processor of any of clauses 11-15, wherein the operations further comprise determining a performance of the embedding model based on the first embedding and the second embedding.

17. The at least one processor of any of clauses 11-16, wherein the second machine learning model comprises a large language model (LLM), a vision language model (VLM), or a multi-modal language model.

18. The at least one processor of any of clauses 11-17, wherein the processing circuitry is comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system implementing one or more vision language models (VLMs); a system implementing one or more multi-modal language models; a system for generating synthetic data; a system for performing one or more generative AI operations; a system incorporating one or more virtual machines (VMs); a system implemented at least partially in a data center; or a system implemented at least partially using cloud computing resources.

19. In some embodiments, a system comprises one or more processors to evaluate a retrieval augmented generation (RAG) pipeline using source data and a plurality of synthetically generated question variants, wherein a plurality of initial questions are generated based at least on processing the source data and persona data using one or more machine learning models, and the plurality of synthetically generated question variants are generated based at least on one or more language models processing the plurality of initial questions and the persona data.

20. The system of clause 19, wherein the system is comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system implementing one or more vision language models (VLMs); a system implementing one or more multi-modal language models; a system for generating synthetic data; a system for performing one or more generative AI operations; a system incorporating one or more virtual machines (VMs); a system implemented at least partially in a data center; or a system implemented at least partially using cloud computing resources.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
inputting a first prompt that includes (i) a first portion of content and (ii) a plurality of user personas into a first machine learning model;
generating, via execution of the first machine learning model and based at least on the first prompt, a plurality of points of interest associated with the plurality of user personas and the first portion of content;
inputting a second prompt that includes a plurality of mappings between the plurality of points of interest and a plurality of question types into a second machine learning model;
generating, via execution of the second machine learning model and based at least on the second prompt, a plurality of questions associated with the plurality of user personas and the first portion of content; and
retrieving a second portion of content based at least on the plurality of questions and a third prompt.

2. The method of claim 1, further comprising:
inputting a fourth prompt that includes (i) the plurality of points of interest and (ii) the plurality of question types into a third machine learning model; and
generating, via execution of the third machine learning model and based at least on the fourth prompt, the plurality of mappings between the plurality of points of interest and the plurality of question types.

3. The method of claim 2, further comprising:
generating a set of clusters associated with the plurality of points of interest; and
deduplicating the plurality of points of interests based at least on the set of clusters prior to inputting the plurality of points of interest into the third machine learning model.

4. The method of claim 3, wherein the set of clusters is generated based at least on a plurality of embeddings of the plurality of points of interest.

5. The method of claim 1, further comprising filtering the plurality of questions based at least on at least one of semantic representations of the plurality of questions, relevances of the plurality of questions to the first portion of content, tones associated with the plurality of questions, or levels of nuance associated with the plurality of questions.

6. The method of claim 1, wherein the generating the plurality of questions comprises converting, via execution of a third machine learning model, each question included in the plurality of questions into a plurality of question variants associated with the plurality of user personas.

7. The method of claim 1, wherein:
the first prompt further includes a first instruction to generate the plurality of points of interest based at least on a first reasoning structure, and
the second prompt further includes a second instruction to generate the plurality of questions based at least on a second reasoning structure.

8. The method of claim 1, wherein the retrieving the second portion of content comprises:
updating one or more parameters of an embedding model based at least on training data that includes the plurality of questions paired with the first portion of content;
generating, via the embedding model after the updating, (i) a first embedding of the third prompt and (ii) a second embedding of the second portion of content; and
retrieving the second portion of content based at least on the first embedding and the second embedding.

9. The method of claim 1, wherein the first machine learning model includes a large language model (LLM), a vision language model (VLM), or a multi-modal language model.

10. The method of claim 1, wherein the plurality of user personas comprises at least one of a name, a role, a behavioral trait, an emotion, a demographic attribute, a communication style, a level of knowledge, a level of education, an attitude, a motivation, an interest, or a goal.

11. At least one processor comprising:
processing circuitry to cause performance of operations comprising:
inputting a first prompt that includes (i) a first portion of content and (ii) a plurality of user personas into a first machine learning model;
generating, via execution of the first machine learning model and based at least on the first prompt, a plurality of points of interest associated with the plurality of user personas and the first portion of content;
inputting a second prompt that includes a plurality of mappings between the plurality of points of interest and a plurality of question types into a second machine learning model;
generating, via execution of the second machine learning model and based at least on the second prompt, a plurality of questions associated with the plurality of user personas and the first portion of content; and
retrieving a second portion of content based at least on the plurality of questions and a third prompt.

12. The at least one processor of claim 11, wherein the operations further comprise:
inputting a fourth prompt that includes (i) the plurality of points of interest and (ii) the plurality of question types into a third machine learning model; and
generating, via execution of the third machine learning model and based at least on the fourth prompt, the plurality of mappings between the plurality of points of interest and the plurality of question types.

13. The at least one processor of claim 11, wherein the generating the plurality of questions comprises converting, via execution of a third machine learning model, each question included in the plurality of questions into a plurality of question variants associated with the plurality of user personas.

14. The at least one processor of claim 13, wherein the generating the plurality of questions further comprises:
generating a set of clusters associated with the plurality of questions; and
deduplicating the plurality of questions based at least on the set of clusters prior to inputting the plurality of questions into the third machine learning model.

15. The at least one processor of claim 11, wherein retrieving the second portion of content comprises:
generating, via an embedding model and based on the third prompt and the plurality of questions, (i) a first embedding of the third prompt and (ii) a second embedding of the second portion of content; and
retrieving the second portion of content based at least on the first embedding and the second embedding.

16. The at least one processor of claim 15, wherein the operations further comprise determining a performance of the embedding model based on the first embedding and the second embedding.

17. The at least one processor of claim 11, wherein the second machine learning model comprises a large language model (LLM), a vision language model (VLM), or a multi-modal language model.

18. The at least one processor of claim 11, wherein the processing circuitry is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system implementing one or more vision language models (VLMs);
a system implementing one or more multi-modal language models;
a system for generating synthetic data;
a system for performing one or more generative AI operations;
a system incorporating one or more virtual machines (VMs);
a system implemented at least partially in a data center; or
a system implemented at least partially using cloud computing resources.

19. A system comprising:
one or more processors to evaluate a retrieval augmented generation (RAG) pipeline using source data and a plurality of synthetically generated question variants, wherein a plurality of initial questions are generated based at least on processing the source data and persona data using one or more machine learning models, and the plurality of synthetically generated question variants are generated based at least on one or more language models processing the plurality of initial questions and the persona data.

20. The system of claim 19, wherein the system is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system implementing one or more vision language models (VLMs);
a system implementing one or more multi-modal language models;
a system for generating synthetic data;
a system for performing one or more generative AI operations;
a system incorporating one or more virtual machines (VMs);
a system implemented at least partially in a data center; or
a system implemented at least partially using cloud computing resources.
